(19) United States
(12) Patent Application Publication
(10) Pub. No.: US 2015/0330639 A1
(43) Pub. Date: Nov. 19, 2015

(54) HEARTH PAD

(71) Applicant: Hestia Inc. (d/b/a American Panel Hearth Products), Grand Haven, MI (US)

(72) Inventors: Jeffrey R. Kreiser, Hudsonville, MI (US); Jeffrey L. Yoder, Gresham, OR (US)

(21) Appl. No.: 14/673,906

(22) Filed: Mar. 31, 2015

Related U.S. Application Data
(60) Provisional application No. 61/993,741, filed on May 15, 2014.

(51) Int. Cl. F24B 1/197; B32B 37/14; B32B 37/12; F24B 1/198

(52) U.S. Cl. CPC F24B 1/197; F24B 1/198; B32B 37/14; B32B 37/12; B32B 2305/72

(57) ABSTRACT

A heat-resistant and spark-resistant hearth pad assembly presents a finished appearance along a floor surface, and supports a wood stove or other heat-generating appliance or device. The hearth pad assembly is transportable in compact form as a kit, and is readily assembled at an installation location, preferably without the use of tools. The hearth pad assembly includes first and second formed panels, such as of sheet metal having a corrugated or undulating cross sectional shape including upper surface portions and lower surface portions, with a generally planar overall shape. The formed panels have opposite side edge portions that are placed near one another and coupled together using a securing element during assembly. A plurality of finishing elements, such as tiles, are typically pre-attached to at least the upper surface portions of the formed panels. Optionally, a framework and/or heat-resistant substrate may be respectively positioned around and beneath the formed panels.

### CROSS REFERENCE TO RELATED APPLICATION

The present application claims the benefit of U.S. provisional application Ser. No. 61/993,741, filed May 15, 2014, which is hereby incorporated herein by reference in its entirety.

### FIELD OF THE INVENTION

The present invention relates to devices for protecting interior building surfaces, such as flooring, from heat and/or sparks generated by fireplaces, woodstoves, furnaces, and the like.

### BACKGROUND OF THE INVENTION

Many different heat-resistant and spark-resistant materials and products are available for protecting flooring, wall panels, and other interior building surfaces from heat and/or sparks that may issue from fireplaces, woodstoves, pellet stoves, furnaces, or other appliances. Such heat-resistant and spark-resistant materials and products may include concrete, tile, metals such as steel, stone, sheet materials having thermal insulating properties, and the like, or combinations thereof. In some installations, the materials or products, such as tile or stone flooring, are permanently installed in a building where a heat-generating appliance or fireplace is to be located. In other installations, a separate product such as a “hearth pad” is sold and installed as a one-piece unit, or as pieces or components that must be assembled together. Conventional hearth pads are typically set in place on or along existing flooring, either with or without fasteners or adhesives to hold it in place.

In the case of a one-piece hearth pad, the hearth pad may be manufactured relatively inexpensively, such as with a sheet of steel wrapped around an insulating substrate such as cement-board, which is functional but not aesthetically desirable. More expensive hearth pads are made with metal frames, an insulating substrate, and a stone or tile top surface that enhances the appearance of the finished product. However, such hearth pads are typically large (often 4 feet square, or more) and heavy, making them bulky and difficult to handle, and some hearth pads require time-consuming on-site assembly and construction, often including wait times for curing of mortar or concrete prior to installing a stove or other appliance atop the pad, which adds cost, installation time, and inconvenience.

### SUMMARY OF THE INVENTION

The present invention provides a hearth pad with the appearance of a custom and permanently-installed unit, but which is packagable and shippable as a kit having significantly smaller dimensions than the finished pad, can have lower cost than products of comparable appearance, and is readily installable without need for tools, without mixing or the application of uncured mortar or adhesives, and typically without specialized skills The hearth pad can be framed for a more finished appearance, if desired, and its thermal insulation properties can be enhanced by adding substrate layers. The product can be manufactured as a kit in different finished sizes, and the finished product is substantially impervious to small sparks due to a continuous non-flammable panel (typically of sheet metal) that is disposed below the tiles, stones, or other materials that form the top surface of the hearth pad.

According to one form of the present invention a hearth pad assembly includes at least two formed panels, a plurality of finishing elements such as tiles, and a securing element that engages and holds adjacent ones of the at least two formed panels together. The formed panels each have a generally planar overall shape, and a non-planar cross section. The formed panels have opposite side edge portions, at least one upper surface portion, and at least one lower surface portion spaced below the upper surface portion. The finishing elements are attached to the upper surface portions of respective ones of the formed panels. The securing element is configured to engage respective opposite side edge portions of the formed panels when the formed panels are in side-by-side arrangement, so that the securing element substantially secures adjacent panels relative to one another.

In one aspect, the securing element engages the respective opposite side edge portions of adjacent panels in a manner so that the securing element is disposed generally above the formed panels and below at least one of the finishing elements.

In another aspect, at least some of the finishing elements extend above and laterally outwardly beyond one of the opposite side edge portions of the formed panel to which finishing elements are attached.

In yet another aspect, each of the formed panels is a sheet metal panel having a generally corrugated shape. The upper surface portions and the lower surface portions include respective elongate and horizontal sections that are substantially planar and aligned parallel to one another, and the formed panels each further include a plurality of upstanding wall portions joining each of the lower surface portions to a respective one of the upper surface portions.

Optionally, each of the opposite side edge portions of the panels includes a respective one of the upper surface portions thereof. The securing element may be an elongate member having an inverted U-shaped cross section including an upper bight portion and a pair of downwardly-extending wall portions. According to this arrangement, the upper bight portion is configured to be disposed directly above both of the respective ones of the opposite side edge portions when the first and second formed panels are in side-by-side arrangement, and the downwardly-extending wall portions of a given securing element are disposed adjacent respective ones of the upstanding wall portions of the formed panels.

In a further aspect, the formed panels together (in combination) include at least six of the upper surface portions and at least five of the lower surface portions. The lower surface portions cooperate with the upstanding wall portions to form at least five elongate channels including at least two opposite outboard end channels and at least three inboard channels, and the at least three inboard channels are lined with respective stiffening elements. Optionally, the stiffening elements are made of cured cement-based material.

In still another aspect, a cured adhesive material is disposed between the finishing elements and the one or more upper surface portions of the formed panels. Optionally, the stiffening element has an upper surface that is substantially flush with the one or more upper surface portions of the formed panels.

In a still further aspect, a frame is positioned around an outer periphery of the formed panels that are jointed together with the securing elements. Optionally, a thermal insulating substrate panel is positioned in the frame and below the formed panels.

In yet another aspect, the hearth pad assembly includes a plurality of adhesive tape sections attached to adjacent ones of the opposite side edge portions when adjacent formed panels are in side-by-side arrangement. Optionally, the adhesive tape sections are further attached to the securing element in a region or gap defined between the adjacent ones of the opposite side edge portions.

According to another form of the present invention, a method is provided for constructing or assembling a hearth pad. The method includes (i) attaching a plurality of finishing elements (such as tiles or the like) to top surface portions of first and second formed panels, (ii) positioning the first and second formed panels in close proximity to one another in a side-by-side arrangement, and (iii) inserting a securing element along respective opposite edge portions of the first and second formed panels to thereby secure the first formed panel relative to the second formed panel.

In one aspect, the step of inserting a securing element includes inserting the securing element in a space defined between bottom surface portions of the finishing elements and top surface portions of the first and second formed panels.

In another aspect, the step of attaching the plurality of finishing elements to the top surface portions of the formed panels includes (i) applying an adhesive material to the top surface portions of the formed panels, (ii) applying the finishing elements atop the adhesive material and the top surface portions of the formed panels, and (iii) curing the adhesive material.

In still another aspect, the method includes stamping or rolling planar sheet metal sections to form the formed panels prior to applying the adhesive material.

In a further aspect, the method includes applying an uncured stiffening material in between the top surface portions of the first and second formed panels, and then curing the stiffening material.

Therefore, the hearth pad and method of assembly of the present invention permits a substantially pre-fabricated hearth pad to be sold and/or shipped as a kit in a relatively compact package, which requires little time and skill to assemble, and which in some applications does not require any cure times at the installation site. Once assembled, the hearth pad has a professional and high quality appearance. The hearth pad's thermal properties can be enhanced as needed or desired with the addition of substrate layers, and can be framed for an even more desirable or professional appearance.

These and other objects, advantages, purposes and features of the present invention will become apparent upon review of the following specification in conjunction with the drawings.

### BRIEF DESCRIPTION OF THE DRAWINGS

FIG. 1 is a perspective view of a hearth pad in accordance with the present invention, shown in use and positioned atop a flooring surface and underneath a wood burning stove;

FIG. 2 is a perspective view of another hearth pad in accordance with the present invention, shown in use and positioned under a wood stove;

FIG. 3 is a partially exploded end elevation of the hearth pad of FIG. 1;

FIG. 3A is an enlarged view of the area designated III-A in FIG. 3;

FIGS. 4A-4F are various views depicting steps of assembling and installing the hearth pad of FIGS. 1 and 3;

FIG. 5 depicts five top perspective views showing steps of assembling the hearth pad of FIG. 2;

FIG. 6 is a series of diagrammatic end elevations showing various optional constructions of the hearth pad of FIGS. 2 and 5; and

FIG. 7 is a series of top plan views of hearth pads depicting various dimensional options based on exemplary standard-length panels and 12-inch square tiles.

### DESCRIPTION OF THE PREFERRED EMBODIMENTS

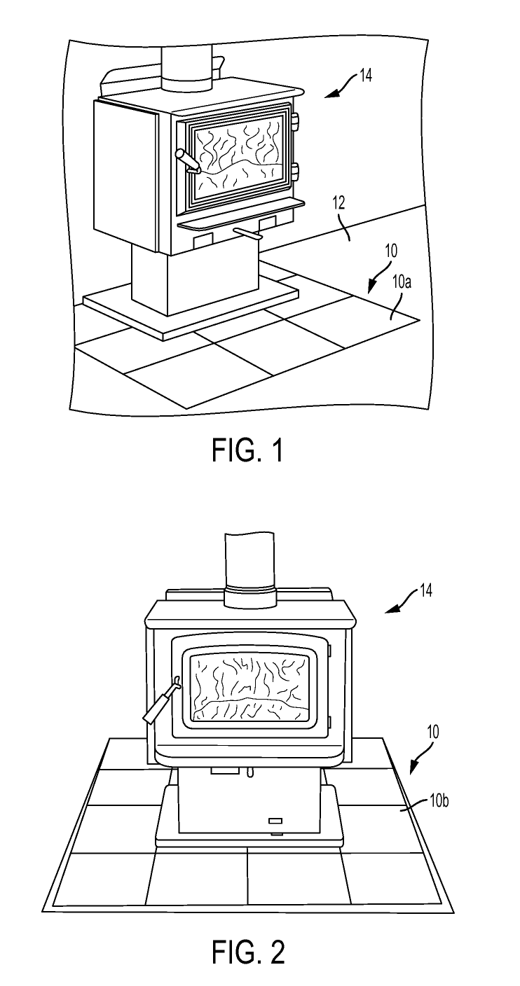

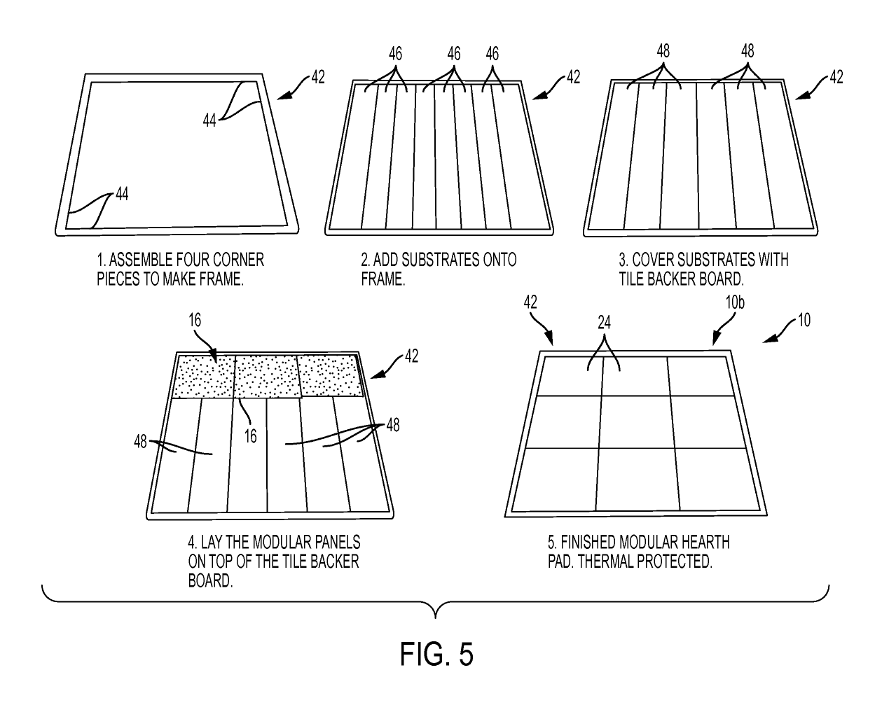

Referring now to the drawings and the illustrative embodiment depicted therein, a hearth pad assembly 10 is provided for protecting a floor surface 12 in the vicinity of a woodstove 14 or other heat-generating device or appliance, such as shown in FIGS. 1 and 2. Hearth pad assembly 10 may be configured as an unframed hearth pad 10a (FIGS. 1 and 3-4F) or as a framed hearth pad 10b (FIGS. 2 and 5) having additional thermal insulation, as will be described below. Hearth pad assemblies 10 are capable of supporting heavy woodstoves 14 as well as pellet stoves, furnaces, or other heating devices or appliances that require heat-resistant and/or flame or spark-resistant materials in their vicinity, such as for safety and for meeting building codes. However, hearth pad assemblies 10 can be packaged and shipped in a compact and partially broken-down form, as in a kit, and assembled at the installation site. In some embodiments, the hearth pad assembly can be fully assembled an installed without tools, and without need for any adhesives or cement-based materials (e.g., tile grout) beyond those that may already be in cured form when the hearth pad assembly is packaged as a kit. In other embodiments, only basic tools may be needed, such as a screwdriver for assembling a basic rectangular frame.

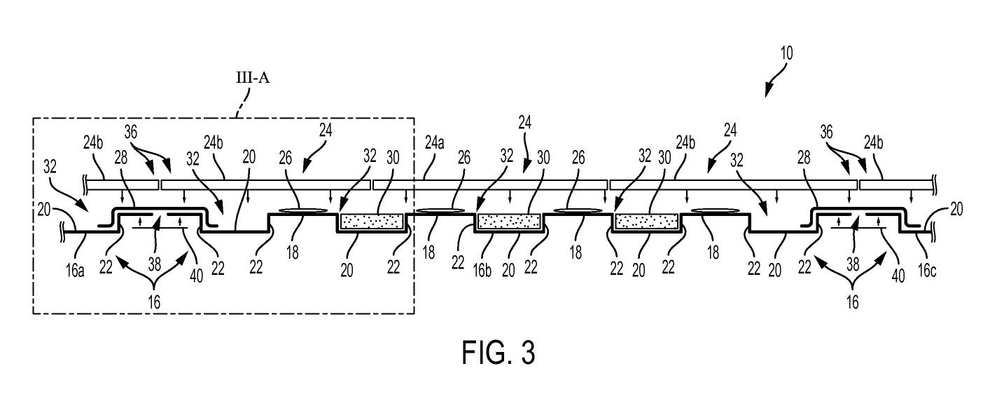

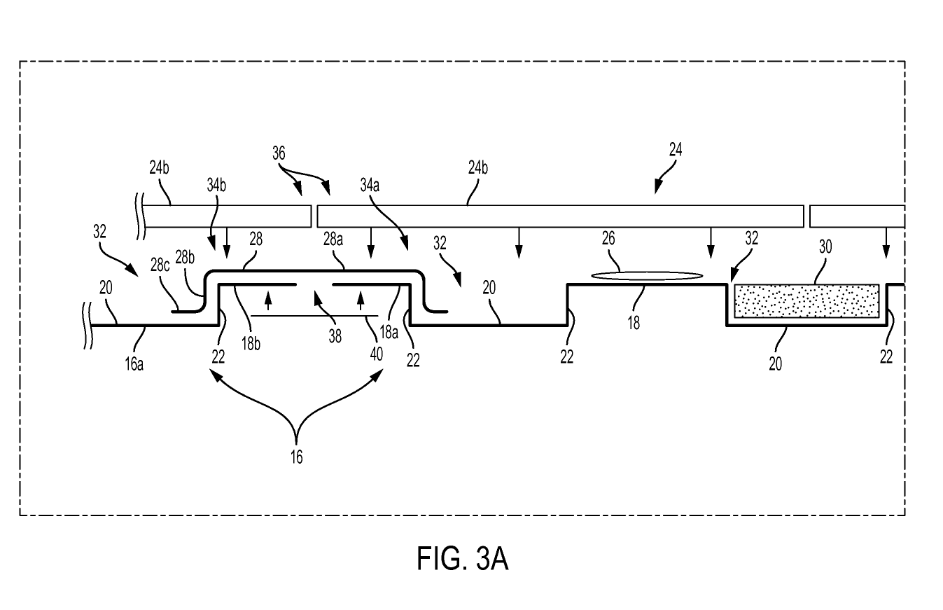

Hearth pad assembly 10 includes a plurality of formed sheet metal panels 16, typically with at least two or three panels 16a-c placed in side-by-side arrangement, such as shown in FIG. 3. Each of the panels 16 has a generally planar overall shape so that it can lie substantially flat along a floor surface or the like, but each panel has a corrugated or undulating shape in cross section or profile, thus forming a plurality of upper surface portions 18 in alternating arrangement with a plurality of lower surface portions 20, with upstanding wall portions 22 disposed between adjacent ones of the upper and lower surface portions 18, 20 (FIGS. 3 and 3A). An elongate securing element 28 is used to secure each formed panel 16 relative to an adjacent formed panel 16, as will be described in more detail below.

Resting atop the upper surface portions 18 are a plurality of finishing elements in the form of natural or man-made tiles 24, which could be substituted with stone pieces or sections, or other suitably strong and heat-resistant and spark-resistant materials. Tiles 24 are bonded in place along upper surface portions 18 using a cured adhesive 26 such as room temperature vulcanizing (RTV) silicone or acrylic, although it is envisioned that other heat-resistant adhesives or mechanical fasteners could be used. Optionally, and as will be described in more detail below, one or more substrate layers (not shown in FIGS. 3 and 3A) may be applied between tiles 24 and upper surface portions 18 of panels 16, or below panels 16, such as to increase rigidity, thickness, and thermal insulating properties of the finished hearth pad 10.

Optionally, an elongate stiffening element 30 is formed or inserted into respective elongate channels 32 that are formed by lower surface portions 20 and corresponding pairs of upstanding wall portions 22 of panels 16. Stiffening elements 30 provide added rigidity, strength, compression resistance, and thermal resistance for panels 16. However, to provide space and clearance for securing elements 28, stiffening elements 30 may be omitted from the two outboard channels 32 located at respective opposite sides of each formed panel 16, such as shown in FIGS. 3 and 3A.

In the illustrated embodiment, stiffening elements 30 are made by pouring an uncured cement-based material, such as thin-set mortar, into each channel 32, and allowing the mortar to cure so that each stiffening element 30, when it cures, is bonded directly to lower surface portions 20 and upstanding wall portions 22. Although thin-set mortar has been found suitable for use as stiffening elements 30, it is envisioned that other materials may be used without departing from the spirit and scope of the present invention. For example, lengths of cement-board or gypsum board may be laid in each channel 32 and bonded in place using a heat-resistant adhesive, mechanical fasteners, or the like.

It will be appreciated that each channel 32 may have its open ends at least temporarily capped or sealed to retain the uncured mortar or other flowable material in channel 32 during the curing process. With reference to FIGS. 3 and 3A, a narrow gap is visible between each stiffening element 30 and the surfaces of panel 16 that define each channel 32, but it will be appreciated that for a poured-in uncured material, the resulting stiffening element 30 will be contacting (and typically bonding to) the corresponding upwardly facing surfaces of lower surface portions 20 and the inwardly facing surfaces of upstanding wall portions 22.

Upper surface portions 18 and lower surface portions 20 are elongate and generally planar sections that are horizontal and aligned in parallel to one another, with upper surface portions 18 all located substantially in an upper plane and with lower surface portions 20 all located substantially in a lower plane that is spaced below the upper plane and generally parallel thereto. In the illustrated embodiment of FIG. 3, the formed panels 16 have six of the upper surface portions 18 (including truncated upper surface portions 18a, 18b) and five of the lower surface portions 20, thereby forming three inboard channels 32 containing stiffening elements 30 and two outboard channels 32 that are substantially open and empty except for the downwardly-extending wall portion 28b and flared end portion 28c of a given securing element 28 upon assembly of hearth panel 10.

Once the tiles 24 have been bonded to respective ones of the individual formed panels 16, the combined tiles 24 and panels 16 may be stacked atop one another for compact packaging and shipping, together with the securing elements 28 and any other desired components, some examples of which will be described below. Optionally, packing material such as thin sheets of foam and/or paper or cardboard may be placed between a given set of tiles and a formed panel positioned directly above, to protect the upper surface finish of the tiles and to reduce the likelihood of other forms of damage during shipping and handling.

As best shown in FIG. 3A, each formed panel 16 has a pair of opposite side edge regions or portions including a left side edge region 34a and a right side edge region 34b. Each side edge region 34a, 34b terminates at a respective truncated upper surface portion 18a, 18b, and includes the outboard-most upstanding wall portions 22 as well as a portion of the outboard-most lower surface portions 20. The tiles 24 include inboard tiles 24a and outboard tiles 24b, where the outboard tiles 24b have outboard edge portions 36 that extend above and laterally outwardly beyond the end of the corresponding truncated upper surface portion 18a or 18b at the respective side edge region 34a or 34b. This arrangement allows adjacent outboard tiles 24b of adjacent formed panels 16 (such as the adjacent panels 16a and 16b shown in FIGS. 3 and 3A, and the adjacent panels 16b and 16c shown in FIG. 3) to be placed in direct contact or abutment, or at close spacing, while leaving a gap 38 between the adjacent truncated upper surface portions 18a or 18b. Gap 38 allows for some adjustment of the tiles 24b relative to one another during installation, to establish a desired alignment of the tiles 24b while minimizing or eliminating any gap that may be present between adjacent outboard edge portions 36 of tiles 24b.

Securing elements 28 have an inverted U-shaped cross section including an upper bight portion 28a and a pair of downwardly-extending wall portions 28b (FIG. 3A). When a given securing element 28 is installed, bight portion 28a spans across two adjacent truncated upper surface portions 18a, 18b and the corresponding gap 38, while downwardly-extending wall portions 28b enter respective channels 32 and generally conform to the corresponding upstanding wall portions 22 and, optionally, with flared end portions 28c disposed above corresponding lower surface portions 20. Thus, securing element 28 substantially covers two adjacent left and right side edge regions 34a, 34b when securing element 28 is installed as shown in FIGS. 3 and 3A. Thus, it can be seen that securing element 28 functions to substantially secure or fix a pair of formed panels 16 relative to one another when the panels are arranged side-by-side, so that one panel cannot be pulled laterally away from the other panel except to a limited extent that might be permitted by the width of bight portion 28a, which facilitates adjustment of adjacent outboard tiles 24b.

Optionally, an upwardly-facing surface of bight portion 28a has a dark colorant applied to it, such as ink, paint, or powder coat material having a black or dark brown color, for example. The dark colorant limits or prevents securing element 28 from reflecting light that would potentially be visible or apparent to persons located near an installed hearth pad assembly in the event that a gap exists or is created between adjacent outboard edge portions 36 of outboard tiles 36. Other upper surfaces may also be tinted or colored a dark color for the same purpose, such as the top surfaces of upper surface portions 18 and of stiffening elements 30.

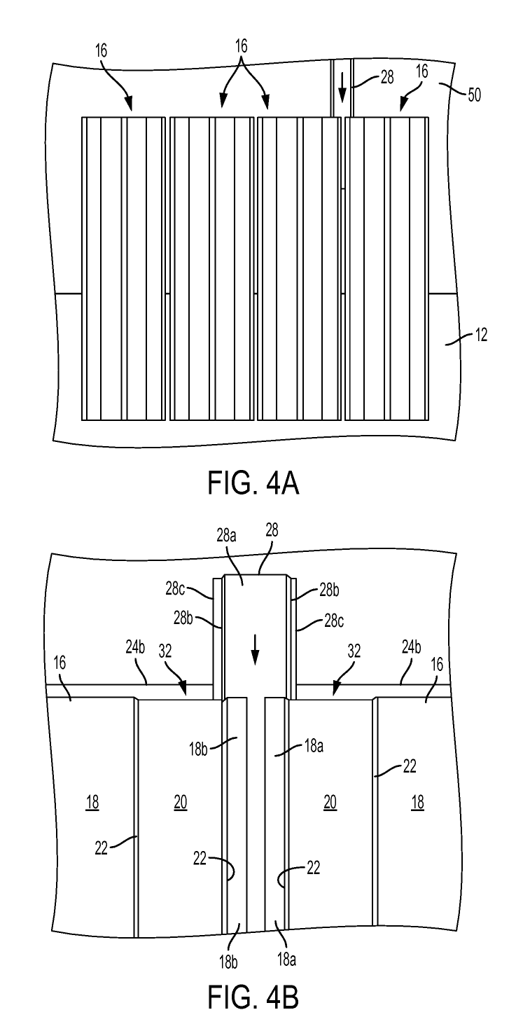

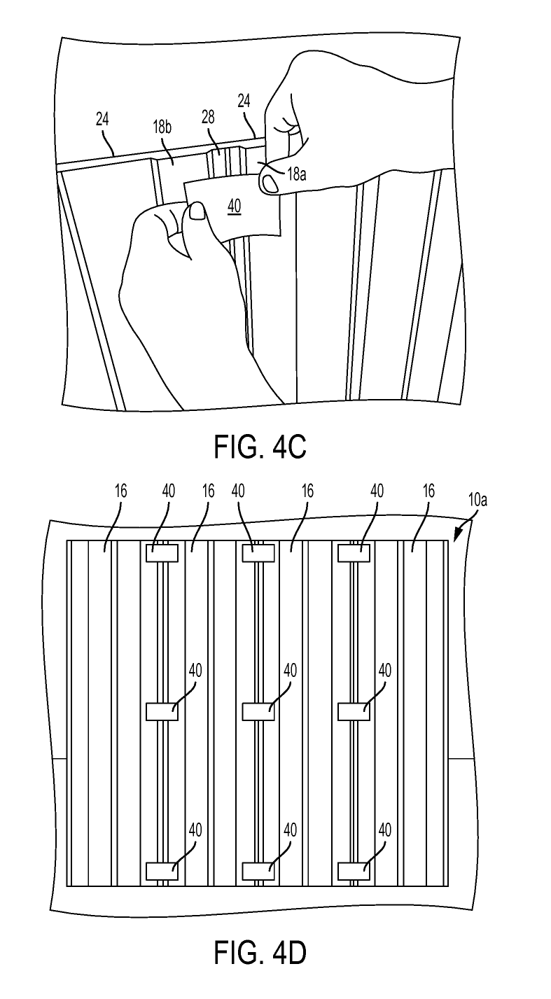

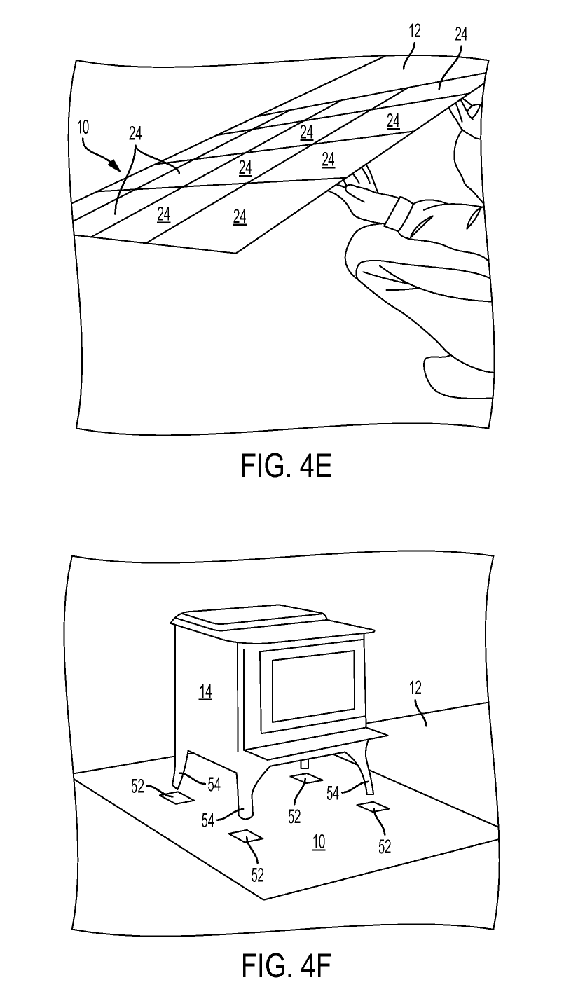

During assembly of hearth panel 10 it may be desirable to apply a plurality of adhesive tape pieces or sections 40 to the undersides of adjacent truncated upper surface portions 18a, 18b when corresponding pairs of adjacent outboard tiles 24b are positioned correctly, such as shown in FIGS. 3, 3A, 4C and 4D. Tape sections 40 span across the corresponding gap 38 and may be sufficiently flexible and have sufficiently strong adhesive so as to also adhere to securing element 28, thus holding it in place relative to truncated upper surface portions 18a, 18b and facilitating final handing and installation of hearth pad assembly such as shown in FIGS. 4E and 4F. Adhesive tape sections 40 may be made from any sufficiently strong substrate and adhesive combination, such as aluminum heat-resistant tape or the like.

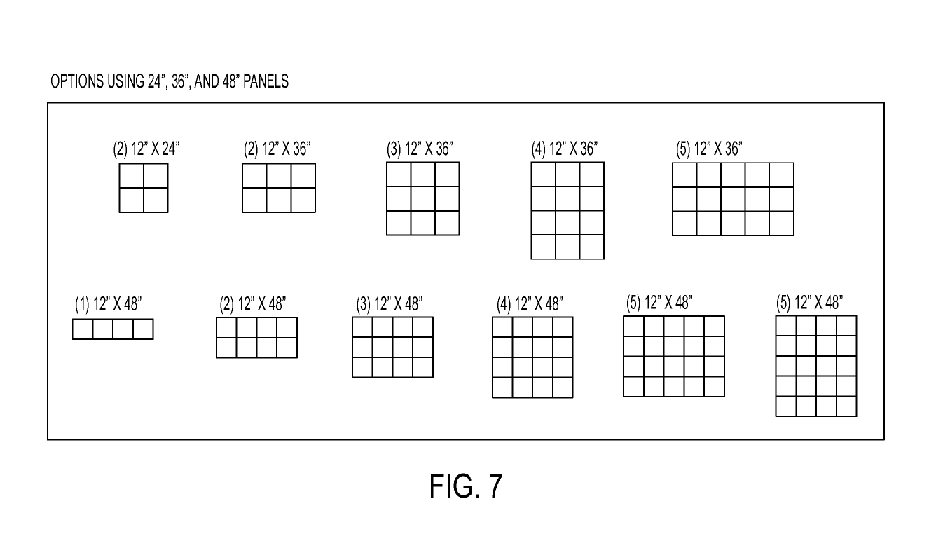

In the illustrated embodiment, formed panels 16 are made from generally planar panels of steel sheeting, and are stamped or roll-formed into their final corrugated or undulating shape. Panels 16 may be cut to substantially any desired length, and it is envisioned that panels 16 would be offered in standardized lengths, such as 2-foot, 3-foot, 4-foot, or 6-foot lengths. Panels 16 may also be formed to substantially any desired width for packaging purposes, with additional panels added to a given kit to form a finished hearth pad assembly having a desired overall width. Standardized lengths and widths, such as in 1-foot increments, may be desirable to ensure compatibility with standard tile sizes without need for cutting tiles, but it will be appreciated that custom sizes and different size increments are equally possible. Different standard sizes are shown in FIG. 7 as illustrative examples.

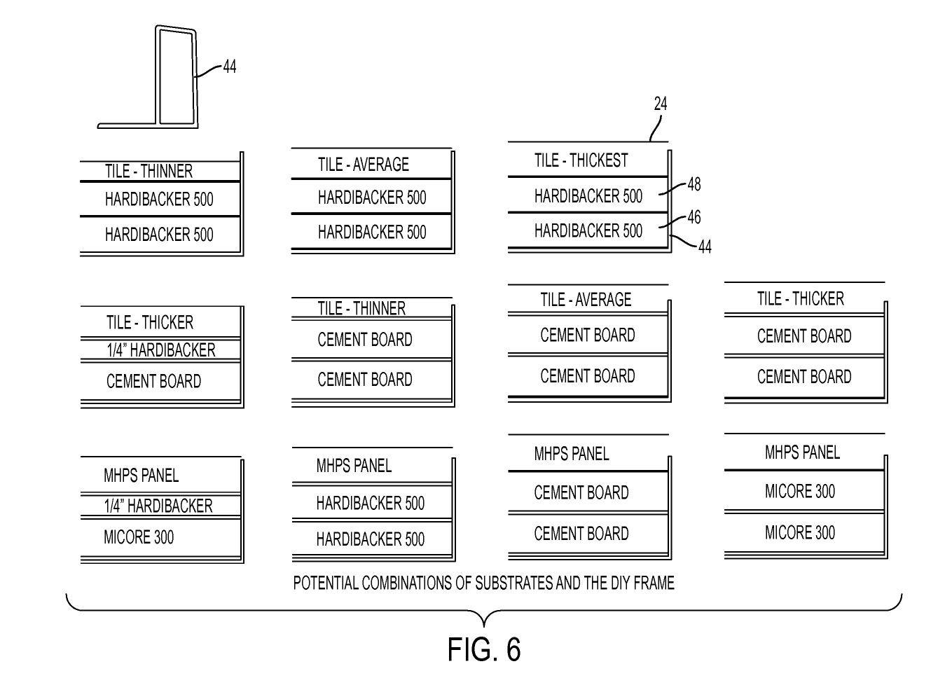

Optionally, and as shown in FIG. 5, a four-sided frame 42 may be constructed from four elongate frame members 44, which may be standard angle-iron or may have a closed section or tubular profile (such as from extruded aluminum, at upper-left in FIG. 6) to present a more finished appearance. Frame 42 may surround only panels 16 and tiles 24, or may be used to support and align one or more heat-resistant substrate sections 46 that are positioned below panels 16 to enhance the thermal insulation value of the finished hearth pad assembly 10b. Suitable materials for substrate panels 46 may include, for example, MICORE® 300 mineral fiber board (available from USG Corp. of Chicago, Ill.), HARDIBACKER® 500 cement board (available from James Hardie Building Products Inc. of Dublin, Ireland and Chicago, Ill.), or substantially any suitable fire-resistant and heat-resistant material. Optionally, a second substrate layer 48 of the same or different material may be applied atop substrate panels 46, such as to raise the overall insulation value of the finished hearth pad assembly 10b. It will be appreciated that many different configurations of substrates 46, 48 and tiles 24 are possible to achieve the desired properties for the finished hearth pad, such as the examples shown in FIG. 6. Formed panels 16 may then be applied atop second substrate layer 48 (or directly atop the first substrate 46, if desired). In the illustrated embodiment of FIG. 5 (at lower-left), formed panels 16 are applied to second substrate layer 48 prior to applying adhesives 26 and tiles 24 to the panels 16 (at lower-right).

Once a given disassembled or “broken-down” hearth pad 10 is delivered to an installation site, such as in kit form, it may be assembled and installed generally as described above and as shown in FIGS. 4A-4F (for unframed hearth pad 10a) and in FIG. 5 (for framed hearth pad 10b). After the components are removed from their packaging, formed panels 16 are stood up on their ends in spaced arrangement along the floor 12 (FIG. 4A), with tiles 24 (not visible in FIG. 4A) facing away from the installer and, optionally, leaning against a wall surface 50 that is preferably protected from damage by a pad, plywood sheet, or the like. Securing element 28 is then inserted from above (FIGS. 4A and 4B) so that it slides between tiles 24 and adjacent truncated upper surface portions 18a, 18b of adjacent panels 16, with downwardly-extending wall portions 28b and flared end portions 28c received in corresponding channels 32 (FIG. 4B). Securing element 28 is slid downwardly until it contacts floor 12, and then the same is done for the remaining securing elements 28. The installer then pushes the panels 16 (and, thus, outboard edge portions 36 of outboard tiles 24b) together, checks for squareness, and applies tape sections 40 at the joints (FIGS. 4C and 4D) as described above, which secures the formed panels 16 and securing elements 28 together, resulting in a finished unframed hearth pad assembly 10a (FIGS. 4D-4F). As noted above, the tiles 24 and elongate stiffening element 30 may be pre-applied to panels 16, but these components are omitted from FIGS. 4A-4D for clarity. The hearth pad assembly 10a can then be lowered into place on to floor surface 12 (FIG. 4E), whereupon it is ready to receive a woodstove 14, such as shown in FIG. 4F.

Optionally, a load-spreading pad 52 may be placed under each leg 54 of the woodstove 14 to protect the tiles 24 (FIG. 4F). Standard trim pieces of wood, metal, fiberglass, or resinous plastic may be added around the perimeter of hearth pad 10 to present a more finished appearance and to protect exposed outer edges of the tiles 24. Frame 42 and one or more layers of substrates 46, 48 may also be laid down along floor 12 prior to installation of the hearth pad, which would result in framed hearth pad 10b (FIGS. 2 and 5) having improved thermal insulating properties.

Accordingly, the hearth pad of the present invention provides a cost-effective product that has the appearance of a custom permanently-installed unit, but which is packagable and shippable as a kit having significantly smaller dimensions than the finished pad, and which is readily installable without need for tools or special skills Typically, all adhesives requiring cure time will have already been applied and cured prior to packaging the kit, so that the installer will not be required to mix, apply, or clean up such products, or wait for such products to cure before continuing with a subsequent assembly or installation step. The hearth pad is readily frameable to present an even more finished, professional appearance, can include substrate layers for added thermal protection, and can be readily manufactured in different sizes without increasing the number of different types of parts required to do so.

Changes and modifications in the specifically-described embodiments may be carried out without departing from the principles of the present invention, which is intended to be limited only by the scope of the appended claims as interpreted according to the principles of patent law including the doctrine of equivalents.

The embodiments of the invention in which an exclusive property or privilege is claimed are defined as follows:

1. A hearth pad assembly comprising:
first and second formed panels, each of said formed panels having a generally planar overall shape and a non-planar cross section with opposite side edge portions, each of said formed panels further having at least one upper surface portion and at least one lower surface portion, wherein said at least one upper surface portion is spaced above said at least one lower surface portion;
a plurality of finishing elements attached to said at least one upper surface portion of respective ones of said first and second formed panels; and
a securing element configured to engage respective ones of said opposite side edge portions of said first and second formed panels when said first and second formed panels are in side-by-side arrangement, wherein said securing element is configured to substantially secure said first formed panel relative to said second formed panel.

2. The hearth pad assembly of claim 1, wherein when said securing element engages said respective ones of said opposite side edge portions of said first and second formed panels, said securing element is disposed generally above said formed panels and below at least one of said finishing elements.

3. The hearth pad assembly of claim 1, wherein at least one of said finishing elements extends above and laterally outwardly beyond at least one of said opposite side edge portions of said formed panel to which said at least one of said finishing elements is attached.

4. The hearth pad assembly of claim 1, wherein each of said formed panels comprises a sheet metal panel, said upper surface portions and said lower surface portions comprise respective elongate and horizontal sections that are substantially planar and aligned parallel to one another, and said formed panels each comprise a plurality of upstanding wall portions joining each of said lower surface portions to a respective one of said upper surface portions.

5. The hearth pad assembly of claim 4, wherein each of said opposite side edge portions comprises a respective one of said upper surface portions.

6. The hearth pad assembly of claim 5, wherein said securing element is an elongate member having an inverted U-shaped cross section including an upper bight portion and a pair of downwardly-extending wall portions, wherein said upper bight portion is configured to be disposed directly above both of said respective ones of said opposite side edge portions when said first and second formed panels are in side-by-side arrangement, and wherein said downwardly-extending wall portions are disposed adjacent respective ones of said upstanding wall portions of said formed panels.

7. The hearth pad assembly of claim 4, wherein said formed panels together comprise at least six of said upper surface portions and at least five of said lower surface portions, wherein said lower surface portions cooperate with said upstanding wall portions to form at least five elongate channels including at least two opposite outboard end channels and at least three inboard channels, and wherein said at least three inboard channels are lined with respective stiffening elements.

8. The hearth pad assembly of claim 7, wherein said stiffening elements comprise cured cement-based material.

9. The hearth pad assembly of claim 1, further comprising a cured adhesive material disposed between said finishing elements and said one or more upper surface portions.

10. The hearth pad assembly of claim 1, further comprising a frame disposed around an outer periphery of said first and second formed panels.

11. The hearth pad assembly of claim 10, further comprising a thermal insulating substrate panel positioned in said frame and positioned below said first and second formed panels.

12. The hearth pad assembly of claim 1, further comprising a stiffening element disposed along at least one of said one or more lower surface portions of each of said first and second formed panels.

13. The hearth pad assembly of claim 12, wherein said stiffening element comprises a cured cement-based material having an upper surface that is substantially flush with said one or more upper surface portions of said first and second formed panels.

14. The hearth pad assembly of claim 1, further comprising a plurality of adhesive tape sections attached to adjacent ones of said opposite side edge portions when said first and second formed panels are in side-by-side arrangement.

15. The hearth pad assembly of claim 14, wherein said adhesive tape sections are further attached to said securing element in a region defined between said adjacent ones of said opposite side edge portions.

16. A method of constructing a hearth pad, said method comprising:
attaching a plurality of finishing elements to top surface portions of first and second formed panels;
positioning the first and second formed panels in close proximity to one another in side-by-side arrangement; and
inserting a securing element along respective opposite edge portions of the first and second formed panels to thereby secure the first formed panel relative to the second formed panel.

17. The method according to claim 16, wherein said inserting a securing element comprises inserting the securing element in a space defined between bottom surface portions of said finishing elements and top surface portions of said first and second formed panels.

18. The method according to claim 16, wherein said attaching the plurality of finishing elements to the top surface portions of the formed panels comprises:
applying an adhesive material to the top surface portions of the formed panels;
applying the finishing elements atop the adhesive material and the top surface portions of the formed panels; and
curing the adhesive material.

19. The method according to claim 18, further comprising stamping or rolling planar sheet metal sections to form the formed panels prior to applying the adhesive material.

20. The method according to claim 16, further comprising:
applying an uncured stiffening material in between the top surface portions of the first and second formed panels; and
curing the stiffening material.
